(19) United States
(12) Patent Application Publication
(10) Pub. No.: US 2005/0060066 A1
(43) Pub. Date: Mar. 17, 2005

(54) Device and method for remote operation of a vehicle from a mother vehicle

(75) Inventors: Bruno Buehler, Stadel bei Niederglatt (CH); Urban Thoeni, Illnau (CH)

Correspondence Address: MCCORMICK, PAULDING & HUBER LLP, CITY PLACE II, 185 ASYLUM STREET, HARTFORD, CT, 06103, US

(73) Assignee: Oerlikon Contraves AG, Zurich (CH)

(21) Appl. No.: 10/896,662

(22) Filed: Jul. 22, 2004

(30) Foreign Application Priority Data
Sep. 16, 2003 (CH) CH 01572/03

(51) Int. Cl. G06F 17/00

(52) U.S. Cl. 701/2; 701/23

(57) ABSTRACT

A device (10) having a first vehicle (11) and a second vehicle (13) which are connected to one another via a communication link (12). The first vehicle (11) has operational units (21), which are actuated in the typical way during driving. In the first vehicle (11), there are connections (23) for transmitting vehicle information (24) which is correlated to the actuation of the operational units (21). Switching means (28) are used for the purpose of switching over the first vehicle (11) from a driving mode into a remote operation mode. A transmitter (27) is used for converting the vehicle information (24) into signals and for transmitting the signals from the first vehicle (11) to the second vehicle (13). The second vehicle (13) includes a receiver (31) for receiving the signals and for converting them into control information. In addition, control elements (32) are provided, which are activatable from the first vehicle (11) by actuating the operational units (21), after the switching means (28) have been brought into the remote operation mode.

The present invention relates to a device and a method for remote operation of a vehicle from a mother vehicle.

The priority of Swiss Patent Application CH 01572/03 of Sep. 16, 2004 is claimed.

The present invention particularly relates to vehicles which may be used to remotely control and/or remotely operate another vehicle by being switched over.

Typically, remotely controllable vehicles are operated from a type of console. For this purpose, the console is provided with different operating elements, such as a joystick and switches. From the console, the appropriate commands are transmitted to the vehicle to be remotely controlled via a radio channel or the like. Depending on the type of the vehicle to be remotely controlled, special command stations are used in order to provide the operating elements and means necessary for the remote operation. These command stations may be complex and costly. Above all, however, they must be transported in each case to the location at which the vehicle to be remotely controlled is to be used.

For example, there are a robot vehicles which are used in special situations. An example is a robot for disarming bombs or a robot which is designed for the purpose of handling critical chemicals. Such robots are transported to the location of use and the command station is unloaded and set up. Only then is use of the robot vehicle possible.

It is an object of the present invention to improve devices of this type and simplify the use of remotely controllable vehicles.

According to the present invention, a device is provided which includes a first vehicle and a second vehicle, both vehicles being connected to one another via a communication link. The first vehicle has operational units which are actuated during driving in the typical way. In the first vehicle, there are connections for transmitting vehicle information which is correlated to the actuation of the operational units. According to the present invention, there are switching means in order to be able to switch over the first vehicle from a driving mode into a remote operation mode. In addition, a transmitter is provided for converting the vehicle information into signals and for transmitting the signals from the first vehicle to the second vehicle. The second vehicle includes a receiver for receiving the signals and for converting them into control information. In addition, control elements are provided, the control elements of the second vehicle being activatable from the first vehicle through actuation of the operational units, after the switching means have been brought into the remote operation mode.

Further advantageous embodiments may be inferred from the depending claims.

A method according to the present invention may be inferred from claim 10 and a further advantageous method is claimed in dependent method claim 11.

Details and advantages of the present invention will be described in greater detail in the following on the basis of exemplary embodiments and with reference to the drawing.

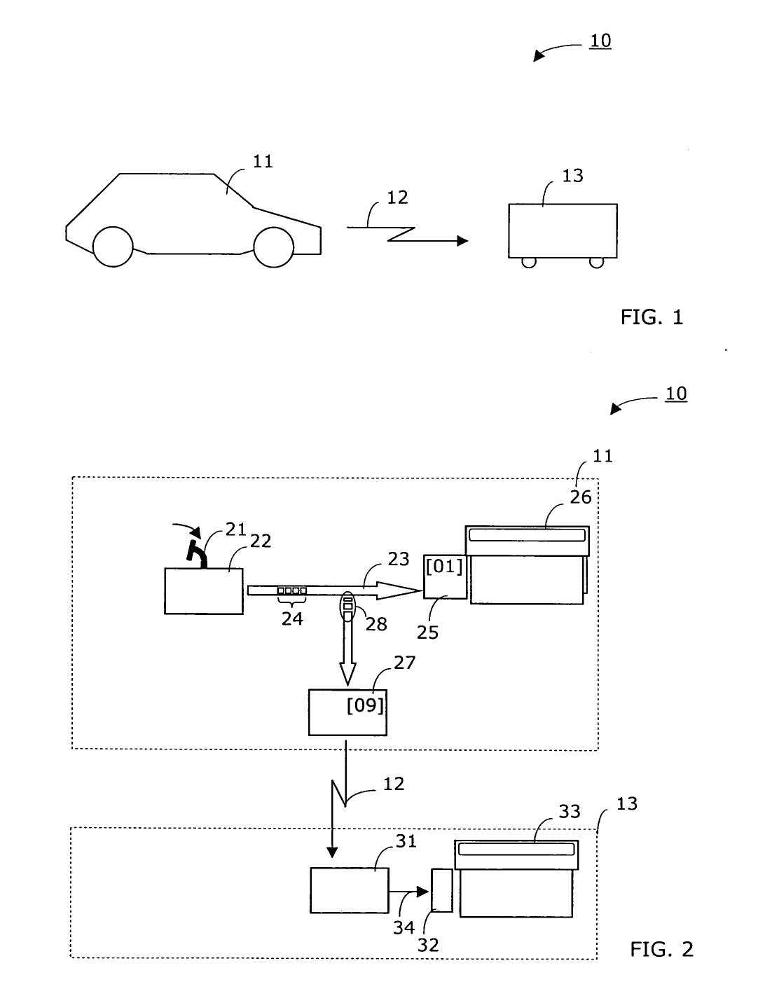

FIG. 1 shows a device having two vehicles in a schematic illustration;

FIG. 2 shows the details of a device according to the present invention in a schematic block diagram;

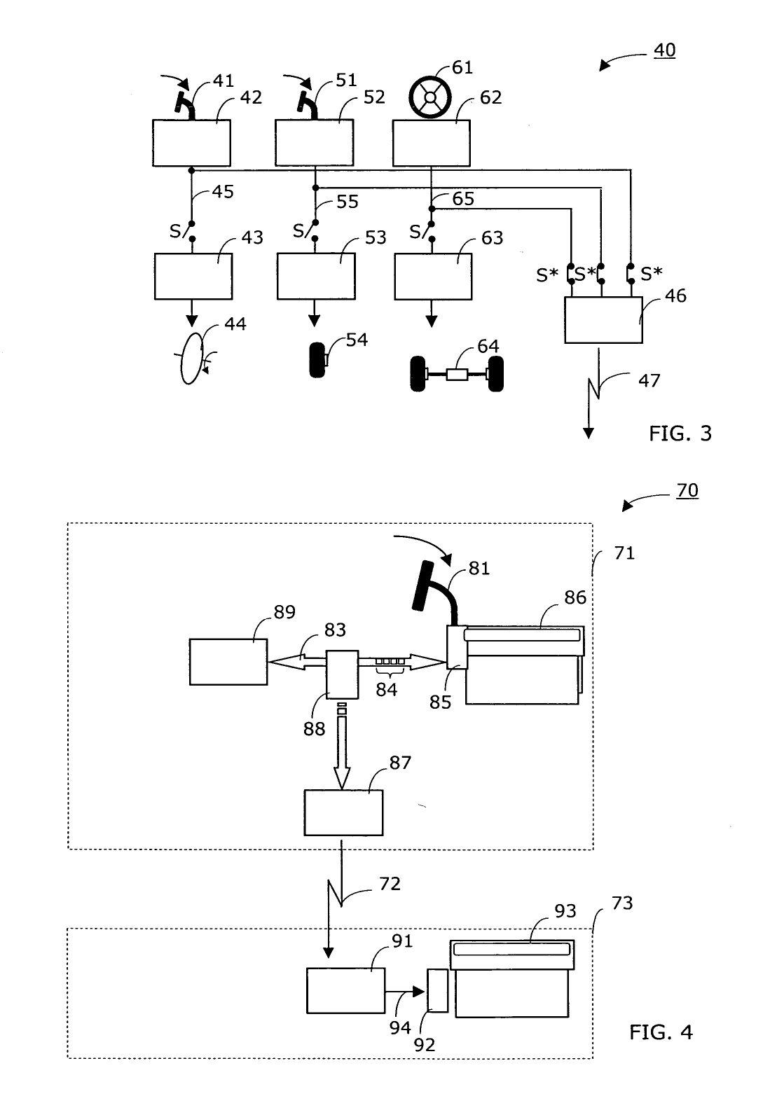

FIG. 3 shows details of a further device according to the present invention in a schematic block diagram;

FIG. 4 shows details of a further device according to the present invention in a schematic block diagram;

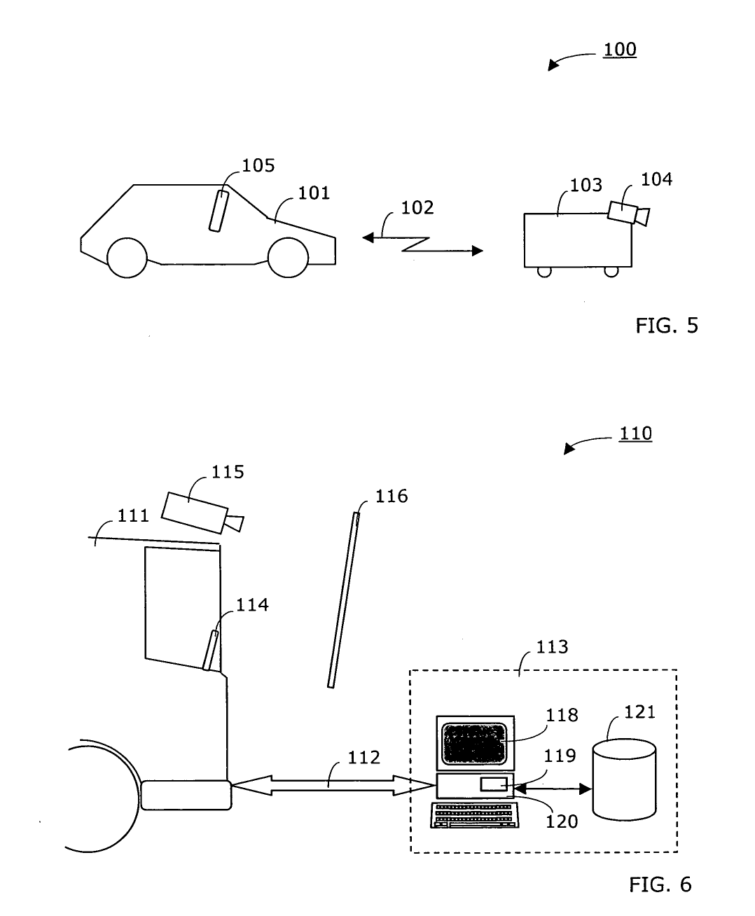

FIG. 5 shows a further device having two vehicles according to the present invention in a schematic illustration;

FIG. 6 shows a further device having a first vehicle and a virtual vehicle according to the present invention in a schematic illustration.

A first device 10 according to the present invention is described in connection with FIGS. 1 and 2. The device 10 includes a first vehicle 11, a second vehicle 13, and a communication link 12 for transmitting signals from the first vehicle 11 to the second vehicle 13. The first vehicle 11 may be a conventional vehicle, such as a passenger automobile, a utility vehicle, such as a truck, a special-purpose vehicle, such as a tank, or the like. The first vehicle 11 is also referred to herein as the mother vehicle.

Among other things, a remotely-controllable robot vehicle, a test vehicle, a prototype vehicle, a simulated vehicle, an emulated vehicle, or the like may be used as the second vehicle 13. The second vehicle 13 is also referred to herein as the remotely-operable and/or remotely-controllable vehicle.

A radio link or an optical link may be used as the communication fink 12. The link may be direct (point-to-point) or indirect (broadcast, for example). However, it is also possible to use a cable or fiber link, the maximum usage radius, i.e., the distance between the mother vehicle and the remotely-operable vehicle, being limited in this way. The communication link 12 may be standardized. Communication links 12 which are based on a standardized communication protocol, such as the Bluetooth standard, are especially suitable. It is also advantageous to use a communication link 12 which is compatible with a controller area network (CAN) or corresponds to the CAN standard.

The information flow via the communication link 12 may be encrypted in order to prevent eavesdropping or external influence.

In order to increase security, the information transmission may be designed as redundant.

Besides numerous components typical in a vehicle, such as a drive unit 26 (engine), a controller 25 (e.g., engine controller and fuel injector), a chassis, a vehicle body, and a passenger space, the first vehicle 11 includes operational units 21 which are actuated during driving of the vehicle 11. These may be, for example, one or more of the following operational units:
a steering wheel,
a gas pedal 21,
a brake pedal,
a clutch pedal,
a gearshift,
switches (such as light switches), etc.

More modern vehicles have a vehicle bus 23 for transmitting vehicle information 24 which is correlated to the actuation of the operational units 21. The vehicle bus 23 may be, for example, a CAN bus or a bus which is compatible with CAN. In drive-by-wire vehicles, at least a part of the operational units are no longer directly connected mechanically or indirectly connected hydraulically to the components to be moved or influenced (steering system, fuel injector, brakes, etc.), but rather there is only an “electronic” connection via a vehicle bus 23.

A drive-by-wire vehicle includes, for example, transducers (e.g., sensors, potentiometers, position pickups, etc.) and control elements (e.g., actuators), which are linked to one another via the redundant vehicle bus 23. The hydraulic and mechanical connections typical until now in the vehicle are replaced by electronic connections 23 and by control elements (e.g., a controller 25, servomotors, and switching elements). A fault-tolerant computer system may be provided, which controls certain actions and engages in emergency situations, for example. The computer of the computer system receives its data in turn from the driver, who transmits his commands to the system using operational units, and also from numerous sensors which detect the current status of the vehicle. A drive-by-wire system may be used, for example, for the steering, acceleration, and braking, shifting and clutching of a vehicle. Through the actuation of operating elements and the transducers connected thereto, the driver triggers signals which are transmitted via the data bus in the form of vehicle information 24 to the control elements as the executing elements (e.g., electrical actuators or a controller 25). This also applies for the steering system, in which feedback to the driver may even be produced via the steering forces.

The brake pedal may, for example, be equipped with a pedal-actuated transducer, which, depending on the actuation, transmits vehicle information via the vehicle bus 23 to the braking system of the vehicle. The braking system is identified here as a control element. In the braking system, the vehicle information is received and converted in order to then build up an appropriate hydraulic pressure and brake the vehicle. The gas pedal 21 may be equipped with a potentiometer used as a transducer 22, which converts the actuation into vehicle information 24 which is supplied via the vehicle bus 23 to a control device 25 as the control element. The control device 25 then injects a quantity of fuel corresponding to the gas pedal setting into the cylinder of the engine 26. For this purpose, the setting of the throttle flap of a gasoline engine 26 may be influenced via a servomotor, for example. Instead of a potentiometer, a pressure sensor or a position pickup may also be used as the transducer 22.

The steering wheel of the vehicle may be connected to a position sensor (e.g., an angle sensor), which, depending on the steering angle, transmits different vehicle information via the vehicle bus 23 to a steering system as the control element.

The vehicle 11, whose details essential to the present invention are schematically shown in FIG. 2, has a central vehicle bus 23, via which all essential vehicle information for the functioning of the drive-by-wire functions is transmitted. The different control elements may be addressed as “receivers” of the vehicle information transmitted by using an addressing scheme typical in networks, for example. This will be described in the following on the basis of the interaction of the gas pedal 21 and the controller 25. For example, if one actuates the gas pedal 21 in such a drive-by-wire vehicle 11, the mechanical actuation is converted into electrical signals by the transducer 22. The electrical signals are converted into digital data which is referred to here as the vehicle information 24. The vehicle information 24 represents the instantaneous setting of the gas pedal 21. For the sake of simplicity, the digital data is shown as packets. Each of the packets, or a series of such packets, may have a header or identifier in order to indicate which of the control elements is the receiver of the data. Therefore, it is ensured that only the desired receiver receives and processes the data. The controller 26 was assigned the “address” [01], for example, as indicated in FIG. 2. The braking system may have the address [02] and the steering system may have the address [03], for example.

It is obvious that besides the addressing cited as an example, there are also other possibilities for assigning data. For example, it is possible to make use of a protocol which uses time slots, each of which contains vehicle information for one of the control elements.

According to the present invention, the vehicle 11 includes switching means 28, in order to be able to switch over from a driving mode to a remote-operation mode. The switching means 28 are only indicated schematically in FIG. 2, since there are different possibilities for implementation. The switching means 28 may be implemented in the form of hardware, software, or as a combination of hardware and software. The following possibilities for switching over are conceivable in a drive-by-wire vehicle 11, these merely being examples:

A switchover or redirection of all relevant vehicle information to a transmitter 27, which is also connected to the bus 23, may be performed by a central unit (e.g., a computer), which is connected to the vehicle bus 23. This may be performed, for example, in that the computer assigns a new address (e.g. [09] in FIG. 2) to the vehicle information to be redirected and therefore all vehicle information is now received and processed only by the transmitter 27.

An ignition key switch or another switch of the vehicle 11 may be brought into a specific setting in which only the transmitter 27, but not the other control elements (such as the controller 25), is active as the receiver. In this case, for example, vehicle information 24 is transmitted to the controller 25, but may not be received there. The transmitter 27 may be designed in such a way that it is capable of receiving a predetermined address range (e.g., vehicle information [01] to [03]).

A mechanical or electronic interruption of certain bus connections may be performed, a connection to the transmitter 27 being maintained or produced, however.

A time slot method may be used for the communication on the bus 23. Certain time slots may then be assigned to the remote operation function. Information which is transmitted in these time slots may then be transmitted over to the transmitter and from there to the second vehicle.

Electro-optical switchover switches may be used.

It is also possible to implement the switchover function using a frequency switchover.

The transmitter 27 is used for converting the vehicle information 24 into corresponding signals and for transmitting the signals via the communication link 12 to a receiver 31, which is located in or on the remotely-operable vehicle 13. The receiver 31 is used for receiving the signals and for converting them into control information. The remotely-operable vehicle 13 also includes control elements, such as a motor 33, having a controller 32, as the drive means. The conversion of the signals is performed in such a way that it is possible to operate the remotely-operable vehicle 13 from the mother vehicle 11. In this case, conversion rules may be applied which take into consideration that, for example, the mother vehicle 11 has a gasoline engine 26 and the remotely-operable vehicle 13 has an electric motor 33 as the drive means. Predetermined characteristic curves or the like may also be applied in the conversion. The conversion may be performed in the mother vehicle and/or in the remotely-operable vehicle.

There is a connection 34 between the receiver 31 and the control elements of the vehicle 13. These may be discretely implemented connections, each of which is situated between only one control element and the receiver 31, or a bus may also be used here.

The vehicles 11 and 13 are built in such a way that the vehicle 13 is remotely operable from the mother vehicle 11 by actuating the operational units 21, after the switching means 28 have been brought into the remote operation mode. If the switching means 28 are in the driving mode, the mother vehicle 11 may be driven normally. The mother vehicle is preferably stopped while the vehicle 13 is remotely operated via the operational units 21.

A further drive-by-wire mother vehicle 40 according to the present invention is schematically shown in FIG. 3. In the example shown, the vehicle 40 includes a throttle-by-wire system, a brake-by-wire system, and a steer-by-wire system.

The throttle-by-wire system includes a gas pedal 41, which is connected to a transducer 42. The transducer 42 may be a potentiometer, for example. The transducer 42 is connected via an individual line 45 to a control element 43. The control element 43 is a servomotor which influences the setting of a throttle flap 44 of a gasoline engine, for example.

The brake-by-wire system includes a brake pedal 51, which is connected to a transducer 52. The transducer 52 may be a pressure sensor, for example. The transducer 52 is connected via an individual line 55 to a control element 53. The control element 53 is a hydraulic braking system 54 which acts on a brake disk of a wheel, for example.

The steer-by-wire system includes a steering wheel 61, which is connected to a transducer 62. The transducer 62 may be a rotary position transducer, for example. The transducer 62 is connected via an individual line 65 to a control element 63. The control element 63 is a hydraulic steering system 64 which acts on the wheels and/or a front axle, for example.

The switchover function according to the present invention is implemented in the example shown as follows: multiple switches are provided which allow the vehicle information transmitted by the transducers 42, 52, 62 to the control elements 43, 53, 63 to be redirected to a transmitter 46. For this purpose, a signal is transmitted to a switch S which opens the switch when a switchover into the remote-operation mode is desired. Switch S*, which is at the input of the transmitter 46, is closed in this case. In contrast, in driving operation the switch S* is open and the switch S is closed.

The transmitter 46 transmits signals to a remotely-controllable vehicle via the communication link 47.

A further embodiment of the present invention is shown in FIG. 4. The device 70 includes a first vehicle and/or mother vehicle 71, a second and/or remotely-controllable vehicle 73, and a communication link 72 for transmitting signals from the mother vehicle 71 to the remotely-controllable vehicle 73. The mother vehicle 71 is not a drive-by-wire vehicle, but rather a conventional vehicle. The connection between the gas pedal operating element 81 and the fuel injector 85 of the diesel engine 86 is of a mechanical nature. However, a vehicle bus 83, which controls certain vehicle functions, is provided in the vehicle 71. For example, vehicle information 84 may be transferred from the fuel injector 85 to a central computer 89 (e.g., an engine management unit) via the vehicle bus 83.

According to the present invention, the vehicle 71 includes switching means 88 in order to be able to change over from a driving mode into a remote operation mode. The switching means 88 conduct vehicle information 84 to a transmitter 87 for converting the vehicle information 84 into signals and for transmitting the signals via a communication link 72 to the remotely-controllable vehicle 73. It is shown as an example in the lower part of FIG. 4 that the remotely-controllable vehicle 73 has a receiver 91 which receives the signals and converts them into control signals which are transferred to control elements. As an example, a drive unit 93 which has a fuel injector 92 is shown. The fuel injector 92 receives electrical signals via a connection 94.

In the event of a switchover from driving operation to remote control operation, the normal operation of the mother vehicle 71 is interrupted. This may be performed, for example, in that the fuel injector 85 is deactivated.

The present invention is especially suitable for being used in drive-by-wire vehicles, in which the currently typical mechanical and hydraulic connections from the steering wheel and pedals to the steering system, drive, and brakes have been partially or completely replaced by an electronic controller. A corresponding embodiment of the present invention was described with reference to FIGS. 1, 2, and 3.

Existing vehicles may be retrofitted by installing or adding on a transmitter and the switching means for remote operation of the second vehicle.

In a first embodiment, the remotely-controllable vehicle may only be operated in the visual range of the person who sits in the mother vehicle and actuates the operating elements.

In a second embodiment, the usage range may be expanded by equipping the remotely-operable vehicle with a camera, an infrared sensor, an ultrasonic transducer, or a radar, to cite only a few examples. An example of a corresponding device 100 is shown in FIG. 5. The remotely-operable vehicle 103 is equipped with a camera 104. The camera 104 may provide image information to the mother vehicle 101, which is displayed there on a display screen 105, via a communication link 102 or via another connection. The communication link 102 is designed as bidirectional in the example shown.

The remotely-operable vehicle may also be provided with gripper arms, actuators, sensors, and other add-ons and extensions. In order to be able to remotely operate these add-ons and extensions, either existing operating elements of the mother vehicle may be used for purposes different from those intended, or special switches, buttons, potentiometers, and the like may be installed in the mother vehicle.

Alternatively or additionally, a separate camera may be used which is not attached to the remotely-operable vehicle.

Preferably, a mother vehicle is designed in such a way that it may transport the remotely-operable vehicle and launch it as necessary. Using the mother vehicle, the remotely-operable vehicle may be brought to a usage location and launched there. For this purpose, the mother vehicle is switched over from driving operation into remote-control operation. By actuating the operating elements of the mother vehicle, the remotely-operable vehicle is then remotely controlled.

The present invention is especially suitable for remotely controlling a robot vehicle. A robot vehicle may be used in dangerous areas, e.g., for disarming bombs, or for handling chemical or biological materials.

According to a further embodiment of the present invention, a virtual second vehicle is used. A corresponding device 110 is shown in FIG. 6 in the form of a block diagram. The device 110 includes a mother vehicle 111, e.g., a utility vehicle, having operating elements 114. Internal connections are provided for transmitting vehicle information. Switching means and a transmitter are coupled to these connections, or linked with these connections, in order to transfer vehicle information to the transmitter if the switching means is brought into a remote-operation mode. These connections, the switching means, and the transmitter are not shown in FIG. 6. Details in this regard may be taken from FIGS. 1 through 5, which are considered as an example.

If the switching means is in the remote-operation mode, the transmitter transmits vehicle information, or signals which are correlated to the vehicle information, to the virtual vehicle 113 via a communication link 112. The communication link 112 may be, a bus for example. The virtual vehicle 113 includes a computer 119, which is equipped in the example shown with an optional display screen 118 and an optional keyboard 120. A receiver, which may be implemented as a plug and card, for example, and is used as the interface between the communication link 112 and the transmitter of the mother vehicle 111, is installed in the computer 119. In addition, an optional storage medium 121 is provided which makes programs and/or data available. The computer 119 is capable of visually displaying certain things (e.g., landscapes or data). The computer 119 may be connected via the communication link 112 to a projector 115, for example, which images image information on a projection screen 116 in front of the utility vehicle 111.

A program is made available to the computer 119 which is capable of emulating at least certain sequences or actions which may arise during operation of the vehicle or a part of the vehicle. For example, it is conceivable that the program represents a virtual representation of a novel steering system for a utility vehicle. Before prototypes of such a steering system are built, a type of simulation may be performed using the device 110. For this purpose, the switching means of the mother vehicle 111 is brought into the remote-operation mode. The driver then actuates the steering wheel 114. Information which represents the actuation of the steering wheel 114 is transmitted via the communication link 112 to the virtual vehicle 113. The computer 119 receives this information and converts it using hardware and/or using the program into input variables which then flow into the emulation. The emulation is a software representation of a control element of the virtual vehicle 113. In the present example, the program emulates the behavior of the novel steering system, for example. The result of the emulation is shown as image information on the projection screen 116, for example.

Such a device allows existing vehicles to be refined without having to perform large interventions in these vehicles.

A similar embodiment may also be used for the purpose of testing a mother vehicle 111 in a simulated environment, or to be able to train a driver in a simulator.

1. A device having a first vehicle, a second vehicle, and a communication link, the first vehicle including:
operational units, which may be actuated as the first vehicle is driven,
connections for transmitting vehicle information which is correlated to the actuation of the operational units,
switching means, in order to be able to switch over the first vehicle from a driving mode into a remote operation mode,
transmitters for converting the vehicle information (into signals and for transmitting the signals from the first vehicle to the second vehicle,
wherein the second vehicle includes:
receivers for receiving the signals and converting them into control information,
control elements, and
the control elements of the second vehicle may be activated from the first vehicle by actuating the operational units, after the switching means have been brought into the remote operation mode.

2. The device according to claim 1, wherein the first vehicle is a drive-by-wire vehicle and the vehicle information preferably represents driver commands.

3. The device according to claim 1,
wherein the first vehicle includes control elements.

4. The device according to claim 3,
wherein the switching means are at least partially implemented as software which causes the switchover from control elements of the first vehicle to control elements of the second vehicle.

5. The device according to claim 4,
wherein the software allows addressing of the transmitter or the control elements of the first vehicle via the connections.

6. The device according to claim 1
wherein a conversion is performed in the first vehicle and/or in the second vehicle.

7. The device according to claim 1,
wherein the first vehicle is a conventional vehicle which is retrofitted for remote operation of the second vehicle by installing or adding on the transmitter and the switching means.

8. The device according to claim 1,
wherein the second vehicle is an emulated or simulated vehicle.

9. The device according to claim 1, which includes means for displaying image information,
wherein a part of these means are positioned in the visual range of a person who operates the first vehicle.

10. A method for remote operation of a remotely-operable vehicle, which is connectable via a communication link to a first vehicle,
wherein the first vehicle includes:
operational units,
switching means, and
a transmitter, and
the remotely-operable vehicle includes:
a receiver, and
control elements, and
the method includes the following steps:
bringing the switching means into a remote operation mode,
actuating the operational units of the first vehicle,
transmitting vehicle information, which is correlated to the actuation of the operational units, to the transmitter,
transferring the information to the receiver,
converting the information into signals or commands for activating the control elements.

11. The method according to claim 10, which includes the following steps:
bringing the switching means into a driving mode,
driving the first vehicle by actuating the operational units.
